(19) United States
(12) Patent Application Publication
(10) Pub. No.: US 2011/0214137 A1
(43) Pub. Date: Sep. 1, 2011

(54) LENS HOLDER AND OPTICAL PICKUP APPARATUS USING THE SAME

(75) Inventors: Mitsuhiro HASHIMOTO, Ota-shi (JP); Ryoichi Kawasaki, Isesaki-Shi (JP)

(73) Assignees: SANYO Electric Co., Ltd., Moriguchi-shi (JP); SANYO Optec Design Co., Ltd., Tokyo (JP)

(21) Appl. No.: 13/035,430

(22) Filed: Feb. 25, 2011

(30) Foreign Application Priority Data
Feb. 26, 2010 (JP) 2010-042998

(51) Int. Cl. G11B 7/135; G11B 7/09

(52) U.S. Cl. 720/681; 720/672; G9B/7.123; G9B/7.083

(57) ABSTRACT

Provided is a lens holder comprising: a mounting hole into which a condenser lens part of the objective lens is to be inserted; a peripheral part which surrounds the mounting hole and on which a flange part of the objective lens is to be mounted; and three protrusions provided in the peripheral part to be spaced apart from each other and to protrude higher than a main surface of the peripheral part. Also provided is an optical pickup apparatus comprising the lens holder and an objective lens supported with a condenser lens part inserted into the mounting hole of the lens holder, and with the flange part being in contact with the three protrusions.

### BACKGROUND OF THE INVENTION

1. Field of the Invention

The present invention relates to a lens holder supporting an objective lens for performing an operation of reading a signal recorded on an optical disc or of recording a signal on an optical disc, and an optical pickup apparatus using the same.

2. Description of the Related Art

As an optical disc apparatus capable of performing an operation of reading a signal or recording a signal by irradiating a signal recording layer of an optical disc with a laser beam emitted from an optical pickup apparatus, ones using optical discs called CD (Compact Disc)-standard or DVD (Digital Versatile Disc)-standard optical discs are generally in widespread use. Meanwhile, there has been recently developed an optical disc apparatus using an optical disc with improved recording density, i.e., an optical disc of Blu-ray Disc (hereinafter referred to as BD) standard or HD-DVD (High Density Digital Versatile Disc) standard.

The optical discs of the CD, DVD, BD and HD DVD standards have signal recording layers provided at different positions from each other. For this reason, in order to perform an operation of reading signals from or recording signals onto the signal recording layers of the different standards, objective lenses focusing laser beams on optical discs of the different standards are manufactured to have numerical apertures NA corresponding to the respective standards.

The higher density of the optical disc apparatus increases difficulty in manufacturing the objective lens compatible with such high density optical discs. Particularly, coma aberration generated when laser beam entrance surface and exit surface of the objective lens are shifted from each other increases with the numerical aperture NA. This means that the objective lens for BD generates the largest coma aberration.

The coma aberration is adjusted in manufacturing of the objective lens or appropriately corrected to be within an allowable range for an optical pickup apparatus after the objective lens is mounted in the optical pickup apparatus. However, it is difficult in the present circumstances to manufacture the objective lens for BD, for example, which only generates the coma aberration within the allowable range for the optical pickup apparatus.

There has been developed a BD/DVD/CD-compatible objective lens which ensures by itself compatibility with the optical discs of all the standards, This objective lens also has a numerical aperture NA of 0.85, resulting in a problem similar to that described above. A complex lens shape for ensuring the compatibility leads to a problem of increases in manufacturing difficulty and coma aberration.

To solve these problems, it is essential to make full use of the objective lens in the optical pickup apparatus by correcting the coma aberration. To be more specific, it is required to measure the amount and direction of coma aberration of each objective lens, and then to mount the objective lens on a lens holder with the objective lens adjusted to tilt at an angle and in a direction for cancelling the coma aberration.

Meanwhile, there is also known an optical disc apparatus compatible with optical discs of the CD and DVD standards and optical discs of the BD and HD DVD standards. This technology is described for instance in Japanese Patent Application Publication No. 2007-73173.

In this case, one lens holder has two objective lenses mounted thereon: one for applying the laser beam to the optical discs of the CD and DVD standards, for example; and the other for applying the laser beam to the optical disc of the Blu-ray Disc standard, for example. This technology is described for instance in Japanese Patent Application Publication No. 2007-287311.

In the optical pickup apparatus having the two objective lenses mounted on one lens holder as described above, relative coma aberration of the two objective lenses is also generated, and the use of the objective lens for BD increases the relative coma aberration. Therefore, in mounting of the objective lenses, adjustment of the objective lenses for correcting the relative coma aberration is generally made in addition to adjustment of the individual objective lenses. This technology is described for instance in Japanese Patent Application Publication No. 2007-287311.

FIG. 12A is a plan view and FIG. 12B is a cross-sectional view taken along the line j-j in FIG. 12A for explaining a conventional objective lens 321 and a conventional lens holder 120.

The objective lens 321 has its condenser lens part 321a inserted into a mounting hole 121 of the lens holder 120. The objective lens 321 is mounted on the lens holder 120 so that a flange part 321b around the condenser lens part 321a comes into contact with a peripheral part (mounting part) 125, of the lens holder 120, surrounding the mounting hole 121, i.e., so that the ring-shaped flange part 321b and the peripheral part 125 come into plane contact with each other.

The objective lens 321 is adjusted to tilt at an optimum angle while checking with an autocollimator or the like, for example. To be more specific, the amount and direction of coma aberration of each objective lens are measured, and the individual objective lens is mounted on the lens holder with the objective lens adjusted to tilt at an angle and in a direction for cancelling the coma aberration. When one objective lens 321 is mounted on one lens holder 120, for example, the objective lens is adjusted using a tilt adjustment function of an actuator. In another case where two objective lenses 321 are mounted on one lens holder 120, the first objective lens 321 is fixed and then the second objective lens 321 is fixed after being adjusted so as to reduce the amount of relative coma of the two objective lenses 321.

However, since the lens holder 120 is a resin-molded article, the lens holder 120 may have slight molding distortion or molding variation in a long axis direction of the lens holder 120 as a whole, for example, depending on filling density or the like. More specifically, a main surface Sf of the peripheral part 125 on which the objective lens 321 is to be mounted actually has slight distortion or variation due to the molding distortion or variation in the lens holder 120 or the peripheral part 125.

When the peripheral part 125 is distorted, the cross-sectional structure shown in FIG. 12B has portions (x-marks in FIG. 12A) bulging higher than a reference plane (horizontal plane) ES' and portions lower than the reference plane. Even when the flange part 321b of the objective lens 321 is brought into contact with the peripheral part 125, a non-contact region may be formed between the peripheral part 125 and the flange part 321b. To be more specific, the flange part 321b is supported by three highest supporting portions PR among the higher portions (bulging portions) of the peripheral part 125.

When the same molding resin and filling density are used for the lens holders 120, the lens holders 120 have, as a whole, similar tendency in molding distortion (e.g., such as a twisting direction or a tilt direction). However, such molding distortion cannot be controlled with high accuracy in terms of its position and height, thus making it impossible to place the objective lens 321 at a desired position and height (angle) on the lens holder 120.

Note that FIG. 12B and other cross-sectional views described below schematically show supporting portions PR. Specifically, the supporting portions PR are shown as narrow convex portions (bulging portions) that can be distinctively illustrated in the cross-sectional view of the preferred embodiment of the invention. However, an entire ring-shaped peripheral part 125 is actually changed in height gently due to a distortion in the entire lens holder 120, and the three highest points in the ring-shaped peripheral part 125 serve as the supporting portions PR.

The objective lens 321 has a small diameter of, for example, 4 mm, and is easily affected by molding distortion or molding variation in the peripheral part 125. If the supporting portions PR cause two ends of the objective lens 321 to have a difference in height of, for example, 7 μm, the objective lens 321 has an angular offset of about 0.1 degree.

In mounting of the objective lenses 321, operators individually perform angle adjustment of the objective lenses 321 one by one. This poses a problem of an adjustment variation due to an occurrence variation in coma aberration in each objective lens 321, the proficiency of each of the operators and other factors. The adjustment variation is further increased with the addition of a factor of molding variation in the lens holder, resulting in problems of performance deterioration and an increase in man-hours due to complicated adjustment work.

When two objective lenses are mounted on one lens holder, the molding distortion or molding variation also causes problems of affecting an adjustment variation between the objective lenses and a variation in correction of relative coma aberration.

### SUMMARY OF THE INVENTION

This invention provides a lens holder supporting an objective lens for focusing a laser beam on a signal recording layer of an optical disc including a mounting hole into which a condenser lens part of the objective lens is to be inserted, a peripheral part surrounding the mounting hole; and three protrusions provided in the peripheral part to be spaced apart from each other and to protrude from a main surface of the peripheral part, and configured to support a flange part of the objective lens by being in contact with the flange part.

The invention also provides an optical pickup apparatus including the lens holder supported by support wires to be movable in a direction perpendicular to a signal recording layer of an optical disc and in a radial direction of the optical disc, and provided with a focus coil, an objective lens supported with a condenser lens part inserted into the mounting hole of the lens holder, and with a flange part around the condenser lens part being in contact with the protrusions.

The invention also provides an optical pickup apparatus including the lens holder supported by support wires to be movable in a direction perpendicular to a signal recording layer of an optical disc and in a radial direction of the optical disc, and provided with a focus coil, an objective lens having a condenser lens part inserted into the mounting hole of the lens holder, and with a flange part around the condenser lens part being in contact with the protrusions, and another objective lens supported with a condenser lens part inserted into the another mounting hole of the lens holder, and with a flange part around the condenser lens part being in contact with the another protrusions.

### BRIEF DESCRIPTION OF THE DRAWINGS

FIG. 1 is a schematic view explaining an optical pickup apparatus according to a first embodiment of the present invention.

FIG. 2 is a schematic view explaining an optical pickup apparatus according to the first embodiment of the present invention.

FIG. 3 is a plan view showing an actuator and a lens holder according to the first embodiment of the present invention.

FIG. 4A is a plan view and FIG. 4B is a cross-sectional view showing an objective lens according to the first embodiment of the present invention.

FIG. 5A is a plan view, FIG. 5B is a cross-sectional view, FIG. 5C is a cross-sectional view and FIG. 5D is a cross-sectional view showing a lens holder according to the first embodiment of the present invention.

FIG. 6 is a cross-sectional view showing the objective lens and the lens holder according to the first embodiment of the present invention.

FIG. 7 is a cross-sectional view showing the objective lens and the lens holder according to a second embodiment of the present invention.

FIG. 8 is a schematic view explaining an optical pickup apparatus according to a third embodiment of the present invention.

FIG. 9 is a plan view showing an actuator and a lens holder according to the third embodiment of the present invention.

FIG. 10A is a plan view and FIG. 10B is a cross-sectional view showing the lens holder according to the third embodiment of the present invention.

FIG. 11 is a cross-sectional view showing objective lenses and the lens holder according to the third embodiment of the present invention.

FIG. 12A is a plan view and FIG. 12B is a cross-sectional view for explaining a conventional technology.

### DESCRIPTION OF THE INVENTION

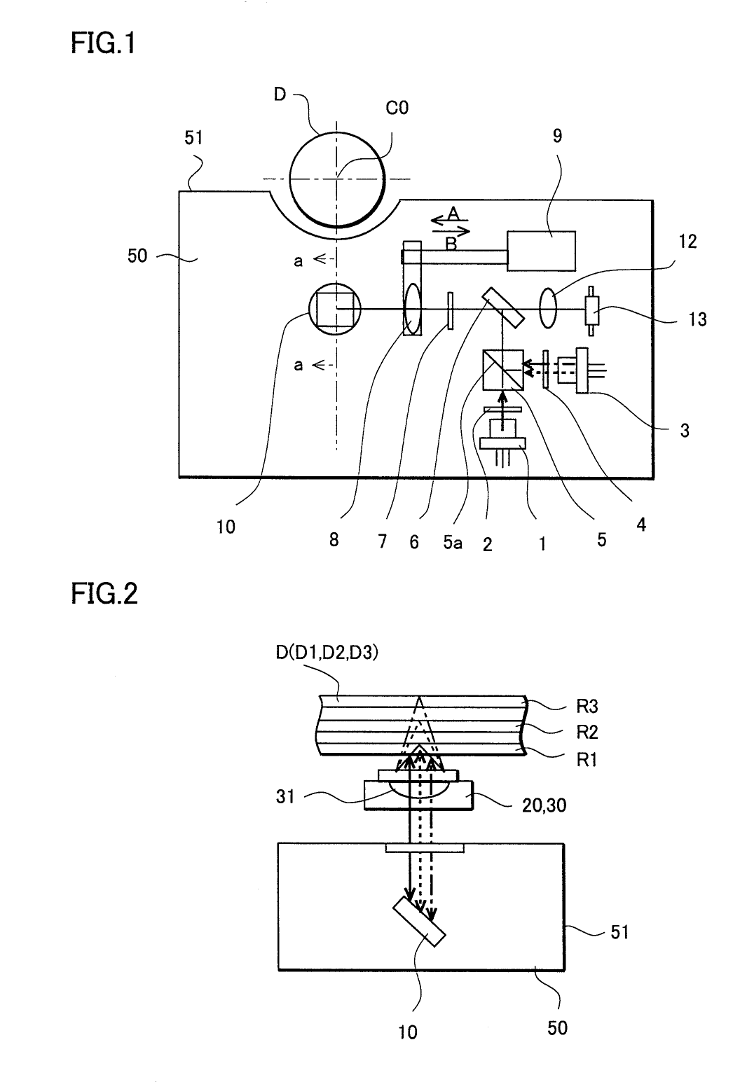

With reference to FIGS. 1 to 11, embodiments of the present invention will be described in detail.

With reference to FIGS. 1 and 2, a general description is given of an optical system of an optical pickup apparatus according to a first embodiment of the present invention. FIG. 1 is a schematic view showing an optical system of an optical pickup apparatus 50 of this embodiment. FIG. 2 is a schematic cross-sectional view taken along the line a-a in FIG. 1, showing a relationship between an optical disc and the optical system. FIG. 2 shows positional relationships between a signal recording layer R1 provided in a first optical disc D1 and an objective lens 31, between a signal recording layer R2 provided in a second optical disc D2 and the objective lens 31, and between a signal recording layer R3 provided in a third optical disc D3 and the objective lens 31.

In this embodiment, description is given of, as an example, an optical pickup apparatus having one objective lens 31 compatible with an optical disc of the Blu-ray Disc (hereinafter referred to as BD) standard (the first optical disc D1), an optical disc of the DVD standard (the second optical disc D2) and an optical disc of the CD standard (the third optical disc D3).

With reference to FIG. 1, the optical pickup apparatus 50 has a first laser diode 1, a first diffraction grating 2, a second laser diode 3, a second diffraction grating 4, a polarization beam splitter 5, a semitransparent mirror 6, a quarter wavelength plate 7, a collimator lens 8, an aberration correction motor 9, a reflecting mirror 10, a sensor lens 12, a photodetector 13 and the like provided in a housing 51.

The first laser diode 1 emits a first laser beam (solid line) that is blue violet light with a wavelength of, for example, 405 nm. The first diffraction grating 2 receives the first laser beam emitted from the first laser diode 1, and has a diffraction grating portion (not shown) which splits the first laser beam into a main beam as 0-order light and two sub-beams as +1-order light and −1-order light.

The first laser beam (solid line) emitted from the first laser diode 1 is set to be P-polarized relative to a control film 5a of the polarization beam splitter 5. As to setting of a linear polarization direction of the first laser beam, the linear polarization direction may be changed by rotating the first laser diode 1 around an optical axis of the first laser beam or by providing a half-wavelength plate between the first laser diode 1 and the polarization beam splitter 5.

The second laser diode 3 is a laser diode which emits laser beams of two different wavelengths, i.e., a second laser beam (broken line) that is red light having a wavelength of, for example, 650 nm and a third laser beam (dashed line) that is infrared light having a wavelength of, for example, 780 nm. The second diffraction grating 4 receives the second or third laser beam emitted from the second laser diode 3, and has a diffraction grating portion (not shown) which splits the received laser beam into a main beam as 0-order light and two sub-beams as +1-order light and −1-order light.

The second or third laser beam emitted from the second laser diode 3 is set to be S-polarized relative to the control film 5a of the polarization beam splitter 5. As to setting of a linear polarization direction of the second or third laser beam, the linear polarization direction may be changed by rotating the second laser diode 3 around an optical axis of the second or third laser beam or by providing a half-wavelength plate between the second laser diode 3 and the polarization beam splitter 5.

The polarization beam splitter 5 is provided with the control film 5a which is provided at a position to receive the first laser beam transmitted through the first diffraction grating 2 and the second or third laser beam transmitted through the second diffraction grating 4, reflects the S-polarized laser beam, and transmits the P-polarized laser beam.

The semitransparent mirror 6 reflects about half of the first laser beam transmitted through the polarization beam splitter 5, and transmits the other half. The semitransparent mirror 6 also reflects about half of the second or third laser beam reflected by the polarization beam splitter 5, and transmits the other half.

The quarter-wavelength plate 7 is provided at a position to receive the three laser beams reflected by the semitransparent mirror 6, and converts the received laser beams from linearly-polarized light into circularly-polarized light and, reversely, from circularly-polarized light into linearly-polarized light. The collimator lens 8 is configured to receive the laser beam transmitted through the quarter-wavelength plate 7, to convert the received laser beam into parallel light, and to be movable in the optical axis direction, i.e., in the direction of arrows A and B by the aberration correction motor 9. A spherical aberration caused depending on the thickness of a protective layer of the optical disc D is corrected by the movement of the collimator lens 8 in the optical axis direction.

The reflecting mirror 10 is provided at a position to receive the three laser beams converted into parallel light by the collimator lens 8, and is configured to reflect the received laser beams toward the objective lens 31.

Each of the laser beam is applied as a focused spot onto the signal recording layer of the optical disc D by the focusing operation of the objective lens 31, and is reflected as return light by the signal recording layer.

The return light enters the semitransparent mirror 6 after passing through the objective lens 31, the reflecting mirror 10, the collimator lens 8 and the quarter wavelength plate 7. About half of the return light thus entering the semitransparent mirror 6 is reflected by the semitransparent mirror 6 and the other half is transmitted through the semitransparent mirror 6 as a control laser beam.

The sensor lens 12 receives the control laser beam transmitted through the semitransparent mirror 6, and irradiates a light receiving part provided in the photodetector 13 called a PD (Photo Diode) IC with the control laser beam having astigmatism added thereto. The photodetector 13 is provided with a well-known four-division sensor or the like, and is configured to perform, by main beam irradiation, a signal generation operation associated with an operation of reading a signal recorded on the signal recording layer of the optical disc D and a focus error signal generation operation for performing a focusing control operation by the astigmatism method, and to perform a tracking error signal generation operation for performing a tracking control operation by application of the two sub-beams. Such control operations for generating the various signals are well-known, and therefore description thereof is omitted.

With reference to FIG. 2, the optical disc D shown as one optical disc D is a collective term for the first to third optical discs D1 to D3, and any one of the first to third optical discs D1 to D3 is actually disposed, from or on which a signal is to be read or recorded. The first optical disc D1 has a short distance from its surface to the signal recording layer R1, while the third optical disc D3 has a long distance from its surface to the signal recording layer R3. Meanwhile, in the second optical disc D2, a distance from its surface to the signal recording layer R2 is longer than that of the first optical disc D1 and shorter than that of the third optical disc D3.

In the above configuration, the first laser beam emitted from the first laser diode 1 enters the objective lens 31 supported by an actuator 30 and a lens holder 20 after passing through the first diffraction grating 2, the polarization beam splitter 5, the semitransparent mirror 6, the quarter wavelength plate 7, the collimator lens 8, and the reflecting mirror 10 (see FIG. 1). The first laser beam is applied as a focused spot to the signal recording layer R1 provided in the first optical disc D1 by the focusing operation of the objective lens 31, and the first laser beam applied to the signal recording layer R1 is reflected as return light by the signal recording layer R1.

In addition, the second or third laser beam emitted from the second laser diode 3 enters the objective lens 31 supported by the actuator 30 and the lens holder 20 after passing through the second diffraction grating 4, the polarization beam splitter 5, the semitransparent mirror 6, the quarter wavelength plate 7, the collimator lens 8, and the reflecting mirror 10 (see FIG. 1). Thereafter, the second or third laser beam is applied as a focused spot to the signal recording layer R2 provided in the second optical disc D2 or the signal recording layer R3 provided in the third optical disc D3 by the focusing operation of the objective lens 31, and the second or third laser beam applied to the signal recording layer R2 or R3 is reflected as return light by the signal recording layer R2 or R3.

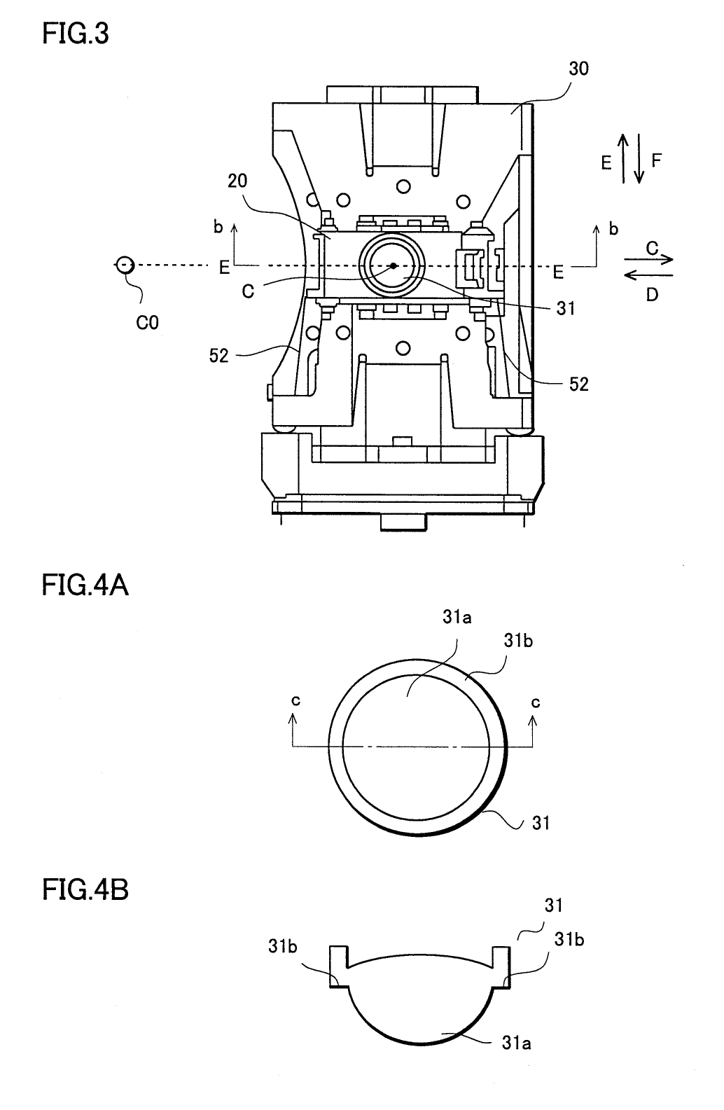

FIG. 3 shows an example of the actuator 30 supporting the lens holder 20.

The lens holder 20 is supported by four support wires 52, for example, and the actuator 30 supports the lens holder 20 so that the lens holder 20 is movable in a focus direction that is a direction perpendicular to the signal recording layer of the optical disc as well as in a radial direction of the optical disc.

Here, the radial direction of the optical disc means a direction of arrows C and D in FIG. 3, i.e., an extending direction of a radial line below the actuator 30 disposed above the optical disc, the radial line connecting the center C0 of the optical disc to the circumference thereof, based on the actuator 30. Moreover, a direction parallel to the surface of the optical disc and at right angle with the radial direction (direction of arrows E and F) is a tangential direction.

A focus coil (not shown) to which a focus drive signal is supplied from the support wires 52 is provided on a sidewall of the lens holder 20, and the focus coil moves the lens holder 20 in the focus direction in cooperation with a magnet (not shown) fixed to the main body of the optical pickup apparatus. Moreover, a tracking coil (not shown) for moving the lens holder 20 in the radial direction is provided to the lens holder 20.

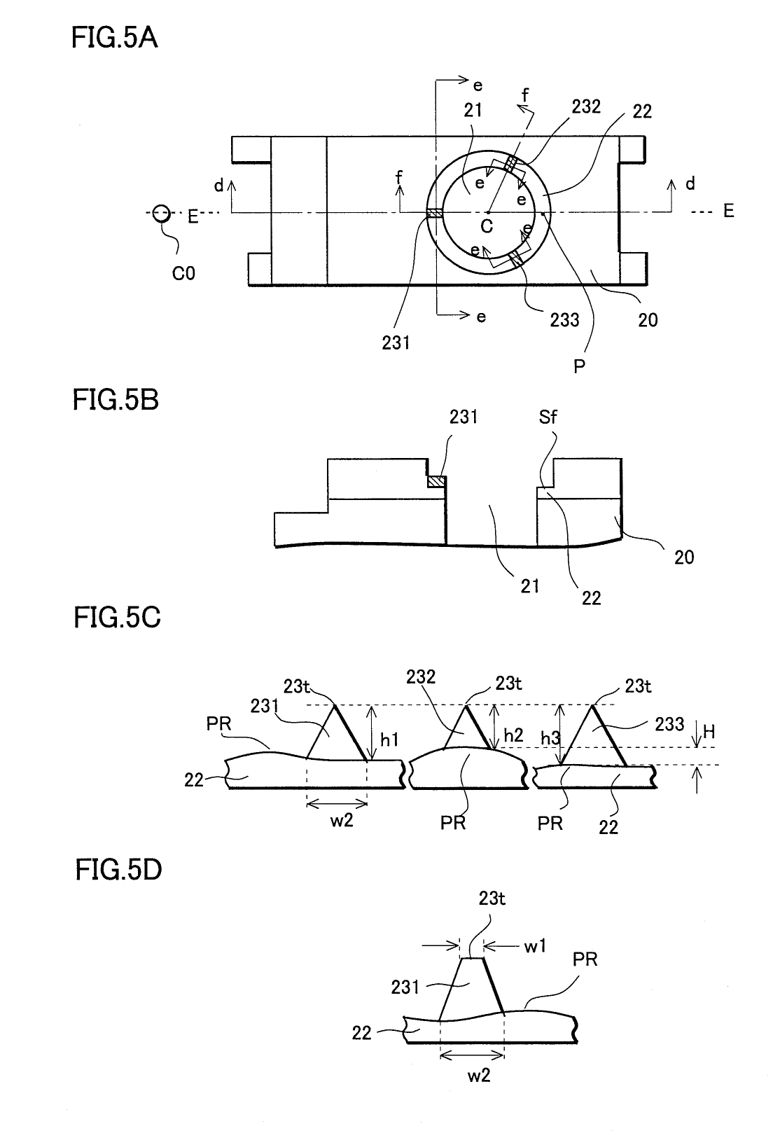

FIG. 4A is a plan view and FIG. 4B is a cross-sectional view taken along the line c-c in FIG. 4A, showing the objective lens 31. FIG. 5A is a plan view, FIG. 5B is a cross-sectional view taken along the line d-d in FIG. 5A, and FIGS. 5C and 5D are cross-sectional views taken along the line e-e in FIG. 5A, showing the lens holder 20 of the first embodiment.

With reference to FIGS. 4A and 4B, the objective lens 31 is an objective lens focusing, by itself, laser beams for reproducing signals on optical discs of the BD, DVD and CD standards, for example, on signal recording layers of the optical discs (i.e., a BD/DVD/CD-compatible objective lens (numerical aperture NA=0.85)). The objective lens 31 has a condenser lens part 31a and a ring-shaped flange part 31b surrounding the periphery of the condenser lens part 31a.

With reference to FIGS. 5A to 5D, the lens holder 20 is resin-molded, and has a mounting hole 21, a peripheral part 22 and three protrusions 231, 232 and 233.

The mounting hole 21 has a circular shape, for example, and has the condenser lens part 31a of the objective lens 31 inserted thereinto. The peripheral part (mounting part) 22 is, for example, a ring-shaped region provided so as to surround the mounting hole 21, and has a shape approximately overlapping with the flange part 31b of the objective lens 31.

The three protrusions 231, 232 and 233 are provided so as to be spaced apart from each other on a main surface Sf of the peripheral part 22, and are regions protruding from the main surface Sf of the peripheral part 22. The main surface Sf of the peripheral part 22 is a flat ring-shaped region in the design of the lens holder 20, but is actually slightly distorted by molding distortion or molding variation in the lens holder 20.

The protrusions 231, 232 and 233 of this embodiment are formed by allowing the resin of the peripheral part 22 to selectively protrude so as to be higher than a difference in height H between supporting portions PR (e.g., 0.7 μm (angle difference of about 0.1 degree)) caused by general molding distortion or molding variation in the lens holder 20.

To be more specific, a peripheral part of a resin mold for the lens holder 20 is selectively subjected to electro-discharge machining, for example, in three spots so that the three protrusions 231, 232 and 233 are formed on the peripheral part 22, thus forming the lens holder 20 using the resin mold.

The protrusions 231, 232 and 233 are provided in the shape of, for example, triangular prisms having heights h1, h2 and h3, respectively, in the cross-section shown in FIG. 5C. These heights h1, h2 and h3 are those that can absorb the difference in height H between the supporting portions PR caused by the molding distortion and molding variation, and are 10 μm to 50 μm, as an example. In this case, apexes of the triangular prisms are referred to as protrusion apexes 23t.

The molding distortion (position, direction and difference in height of the distortion) tends to occur uniformly among multiple lens holders 20 depending on the molding resin of the lens holders 20 and filling density thereof. Then, the tendency of the distortion is grasped based on the molding resin of the lens holders 20 and filling density thereof. Accordingly, the heights h1, h2 and h3 of the protrusions 231, 232 and 233 are selected, respectively, so that the difference in height of the distortion (the difference in height H between the supporting portions PR) can be absorbed.

As a result, the objective lens 31 can be supported at the same position and height even if the supporting portions PR vary in position or height among multiple lens holders 20.

Moreover, the protrusion 231 (the same for the protrusions 232 and 233) may be provided in the shape of a trapezoid in the cross-section as shown in FIG. 5D. In this case, the upper base of the trapezoid is set to be the protrusion apex 23t.

The one protrusion 231 is provided, for example, on a reference line E, of the lens holder 20, passing through the center C of the mounting hole 21. The reference line E is a line serving as the basis for mounting the objective lens 31, and is here a line serving as the basis for aligning the generation directions of coma aberrations in one direction in correcting the coma aberration in the objective lens 31. As an example, the reference line E has the center C0 of the optical disc positioned in its extending direction, and coincides with the radial direction of the optical disc (see FIG. 3).

With reference to FIG. 5A, in the planar view, the ring-shaped peripheral part 22 is split into two halves by a line passing through the one protrusion 231 and the center (point C) of the mounting hole 21 (i.e., the reference line E). The other protrusion 232 is disposed on one of the two arcs of the peripheral part 22, while the remaining protrusion 233 is disposed on the other arc.

It is preferable that the protrusions 231, 232 and 233 are arranged so as to be equally spaced apart from each other. That is, the protrusions 231, 232 and 233 are arranged in 120-degree directions adjacent to each other with the point C as the center.

In this case, one of the protrusions (the protrusion 231) is provided on the reference line E, thereby increasing a radial tilt adjustment margin of the actuator 30 (FIG. 3) supporting the lens holder 20. Thus, a reproduction margin of the optical disc can be increased.

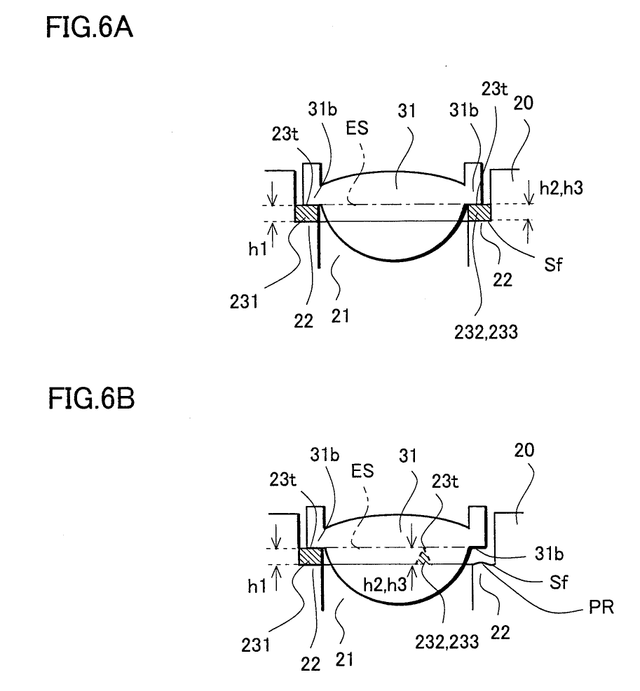

With reference to FIGS. 6A and 6B, description is given of the case where the objective lens 31 is mounted on the lens holder 20 shown in FIGS. 5A to 5D. FIG. 6A is a cross-sectional view of the mounting hole 21 portion in the cross-section taken along the line f-f in FIG. 5A, while FIG. 6B is a cross-sectional view of the mounting hole 21 portion in the cross-section taken along the line d-d in FIG. 5A.

All of the three protrusions 231, 232 and 233 have the heights h1, h2 and h3 higher than the difference in height between the supporting portions PR caused by the molding variation or molding distortion in the peripheral part 22, and thus the flange part 31b of the objective lens 31 is supported by the protrusion apexes 23t thereof. More specifically, the flange part 31b of the objective lens 31 comes into contact with (the protrusion apexes 23t of) the protrusions 231, 232 and 233, thus allowing a plane including the three protrusion apexes 23t to serve as a mounting surface (dashed line) for the objective lens 31. The plane including the three protrusion apexes 23t will be hereinafter referred to as a reference plane ES for mounting the objective lens 31.

By appropriately selecting the heights h1, h2 and h3 of the protrusions 231, 232 and 233, the reference plane ES for mounting the objective lens 31 can be set to be, for example, horizontal to the design main surface Sf of the peripheral part 22 (i.e., the bottom surface or top surface of the lens holder 20). In other words, the objective lens 31 is disposed horizontal to the lens holder 20.

Among the multiple lens holders 20, the respective protrusions 231, 232 and 233 are provided at the same positions on the ring-shaped peripheral part 22 in the planar view (FIG. 5A) and formed with the same heights h1, h2 and h3. Thus, even when molding distortion or molding variation occurs in the surface of the peripheral part 22, the protrusions 231, 232 and 233 can absorb the distortion or variation and stably support the objective lens 31 at the same position and height (angle) among the multiple lens holders 20. More specifically, the reference plane ES for mounting the objective lens 31 is set to be uniform among the lens holders 20.

The objective lens 31 is adjusted for its tilt so that the reference plane ES is tilted at an appropriate angle relative to the optical axis of the laser beam. In this embodiment, the objective lens 31 can be disposed so that the reference plane ES is set to be uniform among the multiple lens holders 20, thus making it possible to prevent an adjustment variation of the objective lens 31 attributable to the molding distortion or molding variation in the lens holder.

Note that when the trapezoidal protrusions 231, 232 and 233 are provided in the cross-section as shown in FIG. 5D, a larger area of the upper surface serving as the protrusion apex 23t (the surface made up of the upper base of the trapezoid) increases the chance of the supporting portions PR being affected by the molding variation on that surface. Therefore, the smaller the area of the upper surface (width w1 in FIG. 5D), the better. A width w2 of the lower base of the trapezoid is set to be equal to or larger than the heights h1, h2 and h3, for example.

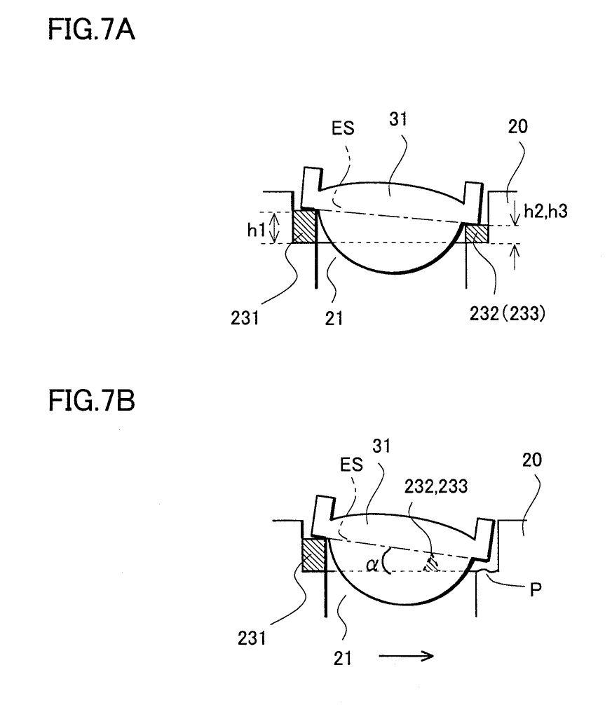

With reference to FIGS. 7A and 7B, a second embodiment of the lens holder 20 is described. FIGS. 7A and 7B are cross-sectional views for explaining the second embodiment. Specifically, FIG. 7A is a cross-sectional view of a mounting hole 21 portion corresponding to the cross-section taken along the line f-f in FIG. 5A, while FIG. 7B is a cross-sectional view of the mounting hole 21 portion corresponding to the cross-section taken along the line d-d in FIG. 5A, both showing the case where the objective lens 31 is mounted on the lens holder 20.

In one lens holder 20, protrusions 231, 232 and 233 may be provided to have such heights that a plane (reference plane ES) including respective protrusion apexes 23t is tilted at a predetermined angle relative to a main surface Sf of a peripheral part 22 (main surface of the lens holder 20).

As shown in FIG. 7A, for example, while setting all the protrusions to have the height to absorb the distortion in the peripheral part 22, the one protrusion 231 is set to have a large height h1 and heights h2 and h3 of the protrusions 232 and 233 are set to be the same and lower than the height h1. Accordingly, the objective lens 31 is tilted relative to the main surface of the lens holder 20. Furthermore, as shown in FIG. 7B, in the cross-section taken along the reference line E of the lens holder 20, the objective lens 31 can be tilted at a tilt angle α so that the protrusion 231 is at the highest and the point P on the peripheral part 22 located at a position 180 degrees from the protrusion 231 (FIG. 5A) is at the lowest.

More specifically, the objective lens 31 having the flange part 31b coming into contact with the protrusions 231, 232 and 233 can have the reference plane ES tilted at a predetermined angle α relative to the plane perpendicular to the optical axis of the laser beam (the plane indicated by the broken line) in the cross-section taken along the reference line E.

The reference plane ES for mounting one objective lens 31 is tilted at the predetermined angle α relative to the plane perpendicular to the optical axis of the laser beam, thereby enabling the optical axis of the objective lens 31 to be within a suitable range relative to the optical axis of the laser beam.

In the objective lens 31, coma aberration is caused by a shift between laser beam entrance surface and exit surface during molding or the tilt of the objective lens 31. That is, such coma aberration can be corrected by tilting the objective lens 31 and thus setting the optical axis of the objective lens 31 within a suitable range relative to the optical axis of the laser beam.

This embodiment employs the configuration in which the peripheral part 22 that is the mounting part of the lens holder 20 is tilted in advance. Thus, adjustments for individual optical pickup apparatuses and for correction of coma aberrations in individual objective lenses can be significantly reduced only by the mounting of the objective lens 31. This makes it possible to reduce an adjustment variation and man-hours and thus to realize an inexpensive optical pickup apparatus having performance associated with no practical problem.

To be more specific, the predetermined angle α is an angle at which the coma aberration can be absorbed to some extent. The objective lens 31 is mounted and fixed so that the generation direction of coma aberration is aligned with the tilt direction. Here, the tilt direction means a direction in which the lens is tilted at the tilt angle α so that the protrusion 231 (center side of the optical disc) is at the highest and the point P of the peripheral part 22 (outer circumferential side of the optical disc) located at a position symmetrical to the protrusion 231 about the center C of the mounting hole is at the lowest, as indicated by the arrow in FIG. 7B, for example, in the cross-section taken along the reference line E.

As the angle at which the coma aberration can be absorbed to some extent, the tilt angle α is set to be an angle that is one-half of an angle corresponding to the maximum amount of coma aberration generated by the objective lens 31.

The amount of coma aberration varies from one objective lens 31 to another. In this regard, however, the tilt angle α of the reference plane ES of the objective lens 31 determined by the heights of the protrusions 231, 232 and 233 is previously set to be the angle that is one-half of the angle corresponding to the maximum amount of coma aberration generated, thereby, though the extent is different, achieving the same effect as the significant reduction in the amount of coma aberrations generated by all the objective lenses 31 mounted.

As an example, in the case of the objective lens 31 having compatibility with the optical discs of the BD, DVD and CD standards, the tilt angle α is set to be an angle (0.25 degree) that is one-half of an angle (approximately 0.5 degree) corresponding to the maximum amount of coma aberration generated by the objective lens 31.

In mounting of the objective lens 31, the objective lens 31 is mounted while being rotated so that the generation direction of coma aberration is aligned with the tilt direction.

In this embodiment, the reference line E coincides with the radial direction, and the tilt direction also coincides with the radial direction. By making the tilt direction coincide with the radial direction of the optical disc as described above, the direction of coma aberration can be aligned with the radial direction of the optical disc.

Note that, here, the description has been given of the objective lens 31 which realizes by itself the compatibility with the optical discs of the BD, DVD and CD standards, but the present invention is also applicable to objective lenses compatible with the optical disc for BD and optical disc for DVD, respectively.

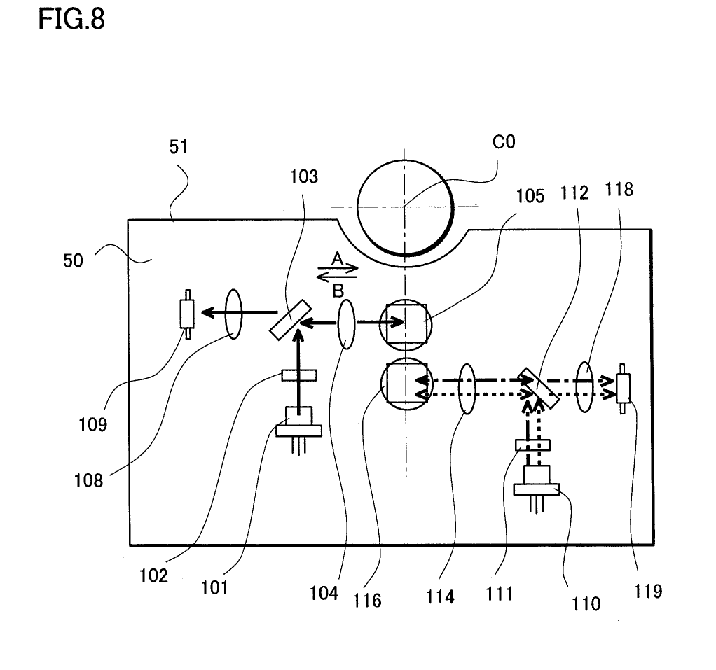

For example, the objective lens for BD has the same numerical aperture NA, and is thus the same as the embodiment described above. On the other hand, in the case of the objective lens for DVD, the protrusions 231, 232 and 233 are provided so that the tilt angle α is set to be an angle (0.15 degree) that is one-half of an angle (approximately 0.3 degree) corresponding to the maximum amount of coma aberration generated by the objective lens for DVD. Next, with reference to FIGS. 8 to 11, a third embodiment of the present invention is described. FIG. 8 is a schematic view of an optical system of an optical pickup apparatus according to the third embodiment of the present invention.

One lens holder 20 may have multiple objective lenses mounted thereon. Here, description is given of, as an example, the case where two objective lenses are mounted on one lens holder in an optical pickup apparatus compatible with an optical disc of the BD standard (a first optical disc), an optical disc of the DVD standard (a second optical disc) and an optical disc of the CD standard (a third optical disc). For example, an objective lens for BD is used as a first objective lens 31, and an objective lens for DVD/CD is used as a second objective lens 32.

In FIG. 8, a laser diode 101 emits a first laser beam (solid line) that is blue light having a first wavelength of, for example, 405 nm. The first laser beam enters a polarization beam splitter 103 through a first diffraction grating 102. The polarization beam splitter 103 reflects the first laser beam that is S-polarized, and transmits the first laser beam polarized in a P-direction.

The first laser beam is set to be S-polarized relative to a control film of the polarization beam splitter 103. As to setting of a linear polarization direction of the first laser beam emitted from the laser diode 101, the linear polarization direction may be changed by rotating the laser diode 101 around an optical axis of the first laser beam or by providing a half-wavelength plate between the laser diode 101 and the polarization beam splitter 103.

A first collimator lens 104 receives the laser beam reflected from the polarization beam splitter 103 and converts the received laser beam into parallel light. Furthermore, the first collimator lens 104 is provided to be movable in directions of arrows A and B by an unillustrated motor for correcting spherical aberration caused by a protective layer of the optical disc (not shown here) of the BD standard.

A first reflecting mirror 105 receives and reflects the first laser beam. A first quarter-wavelength plate 106 converts the first laser beam from linearly-polarized light into circularly-polarized light. The first laser beam converted into the circularly-polarized light by the first quarter-wavelength plate 106 enters the first objective lens 31 provided to focus the laser beam on the signal recording layer R1 provided in the first optical disc D1.

The first laser beam focused on the signal recording layer R1 of the first optical disc D1 by the first objective lens 31 is reflected as return light from the signal recording layer R1 and then enters the first objective lens 31. In this way, the return light that has entered the first objective lens 31 enters the polarization beam splitter 103 through the first quarter-wavelength plate 106, the first reflecting mirror 105 and the first collimator lens 104.

The return light is transmitted through (the control film of) the polarization beam splitter 103, incident on a first sensor lens (anamorphic lens) 8.

A first photodetector 109 is provided at a position where the return light having passed through the first sensor lens 108 is focused and applied, and is made up of a four-division sensor having photodiodes disposed therein, and the like.

A two-wavelength laser diode 110 is a laser diode which emits laser beams of two different wavelengths, i.e., a second laser beam (broken line) that is red light with a second wavelength of, for example, 650 nm and a third laser beam (dashed line) that is infrared light with a third wavelength of, for example, 780 nm.

The second or third laser beam is transmitted through a second diffraction grating 111 and enters a beam splitter (semitransparent mirror) 112. The beam splitter 112 is provided with a control film (not shown) which reflects and transmits the second or third laser beam. Note that a polarization beam splitter and a half-wavelength plate may be provided in place of the beam splitter 112.

The second or third laser beam is converted into parallel light by a second collimator lens 114, and then enters a second reflecting mirror 116. The second reflecting mirror 116 reflects the second or third laser beam toward the second objective lens 32 provided to focus the second laser beam (broken line) on the signal recording layer R2 provided in the second optical disc D2 and to focus the third laser beam (dashed line) on the signal recording layer R3 provided in the third optical disc D3.

The second or third laser beam is converted from linearly-polarized light into circularly-polarized light by a second quarter-wavelength plate 113.

The second or third laser beam focused on the signal recording layer R2 of the second optical disc D2 or the signal recording layer R3 of the third optical disc D3 by the second objective lens 32 is reflected as return light from the signal recording layer R2 or R3 and then enters the second objective lens 32. In this way, the return light that has entered the second objective lens 32 enters the beam splitter 112 through the second quarter-wavelength plate 113, the second reflecting mirror 116 and the second collimator lens 114.

The return light transmitted through (the control film of) the beam splitter 112 enters the sensor lens 118 and is focused and applied onto a second photodetector 119.

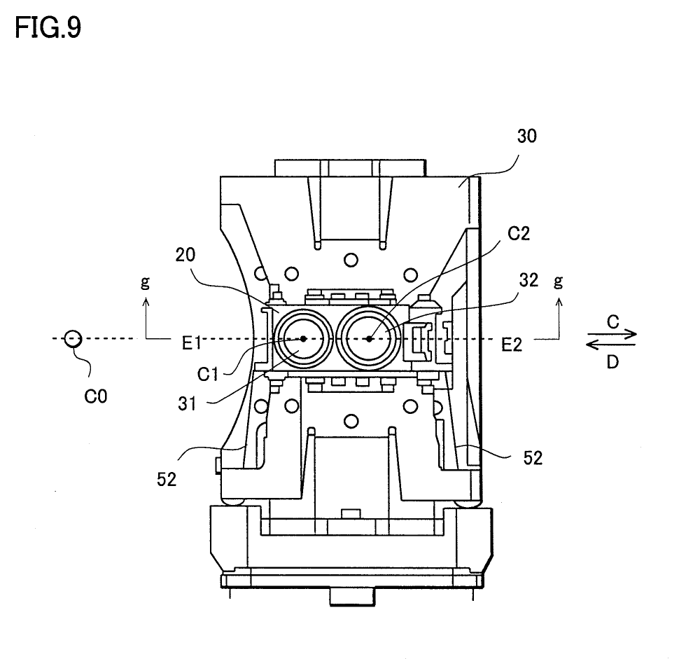

FIG. 9 is a plan view showing an actuator 30 supporting the lens holder 20 of the third embodiment.

The actuator 30 has approximately the same configuration as that described in the first embodiment (FIG. 3), and therefore detailed description thereof is omitted. The lens holder 20 is supported by the actuator 30 so that, for example, a straight line connecting the center C1 of a first mounting hole 21 for the first objective lens 31 and the center C2 of a second mounting hole 24 for the second objective lens 32 coincides with the radial direction of the optical disc (direction of arrows C and D). Here, as an example, the center C0 of the optical disc and the centers C1 and C2 of the first and second mounting holes 21 and 24 are positioned on the same line.

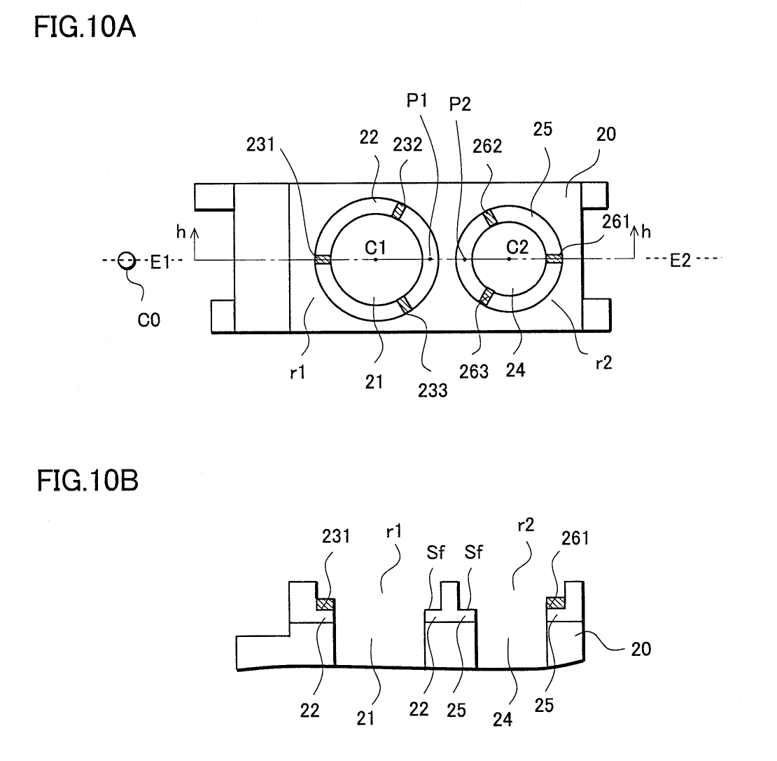

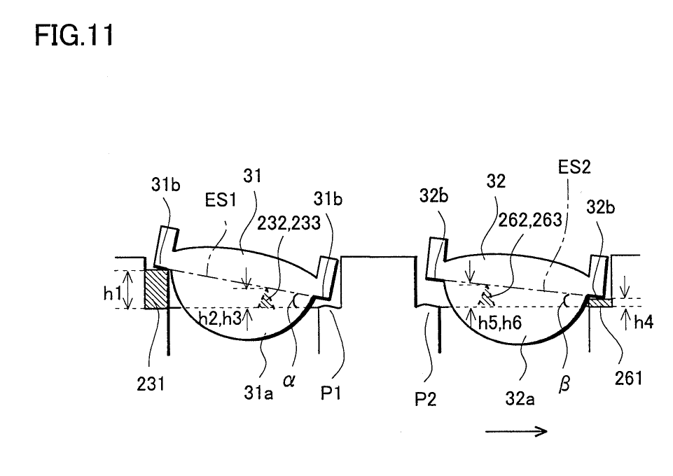

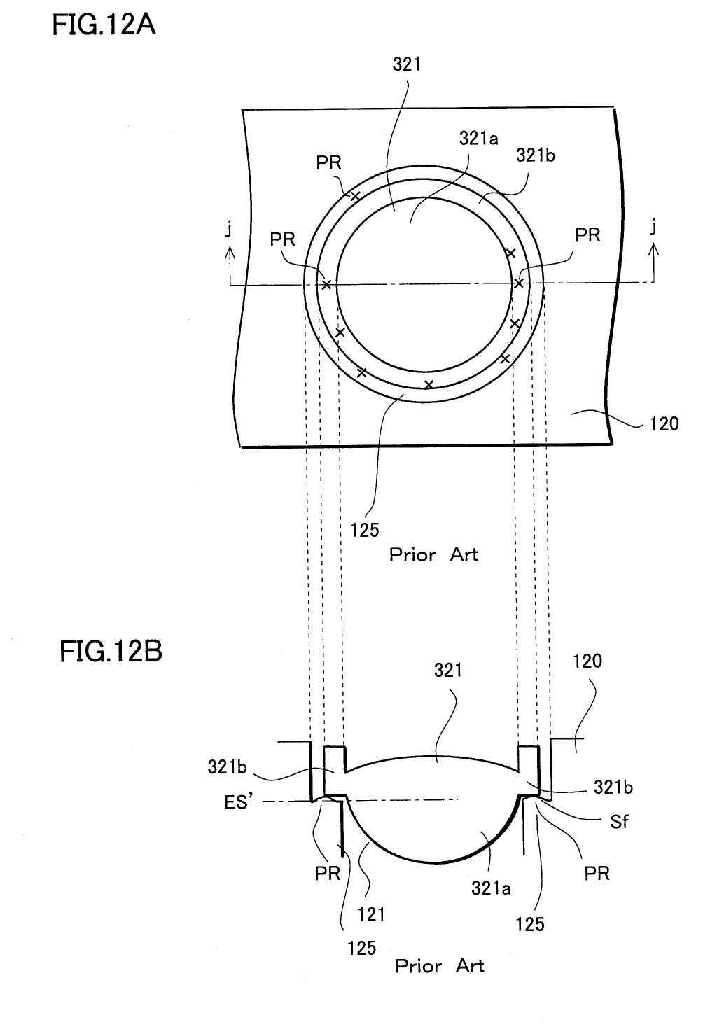

FIG. 10A is a plan view and FIG. 10B is a cross-sectional view taken along the line h-h in FIG. 10A, showing the lens holder 20. FIG. 11 is a cross-sectional view taken along the line h-h in FIG. 10A, showing the case where the first and second objective lenses 31 and 32 are mounted on the lens holder 20.

The lens holder 20 includes: the first mounting hole 21, the first peripheral part 22 and three first protrusions 231, 232 and 233, which are provided in a first objective lens mounting region r1; and the second mounting hole 24, a second peripheral part 25 and three second protrusions 261, 262 and 263, which are provided in a second objective lens mounting region r2.

The first objective lens mounting region r1 has the same configuration as that described in the second embodiment, and therefore description thereof is omitted.

While the second objective lens mounting region r2 has approximately the same configuration as that of the first objective lens mounting region r1, details thereof are as follows.

The mounting hole 24 has a circular shape, for example, and has a condenser lens part 32a of the second objective lens 32 inserted thereinto (see FIG. 11). The second peripheral part 25 is, for example, a ring-shaped region provided so as to surround the second mounting hole 24, and approximately overlaps with a flange part 32b of the second objective lens 32.

A first reference line E1 and a second reference line E2 passing through the centers C1 and C2 of the first and second mounting holes 21 and 24, respectively, coincide with each other here, as an example, and coincide with the radial direction of the optical disc. The first and second reference lines E1 and E2 are lines serving as the basis for aligning the generation directions of coma aberrations in one direction in correcting the coma aberrations of the first and second objective lenses 31 and 32.

The three second protrusions 261, 262 and 263 are provided so as to be spaced apart from each other on a main surface Sf of the second peripheral part 25, and are regions protruding from the main surface Sf of the second peripheral part 25. The second protrusions 261, 262 and 263 are formed by allowing the resin of the second peripheral part 25 to selectively protrude (using a resin mold with protruding resin). The heights of the second protrusions 261, 262 and 263 are appropriately selected based on the molding resin, filling density or the like so that the second protrusions are higher than a difference in height (difference in height H between supporting portions PR) caused by general molding distortion or molding variation in the lens holder 20.

The second protrusions 261, 262 and 263 are provided in the shape of a triangular prism or a trapezoid in the side section, for example (see FIGS. 5C and 5D).

The one second protrusion 261 is provided, for example, on the second reference line E2. The ring-shaped second peripheral part 25 is split into two halves by a line passing through the one second protrusion 261 and the center C2 of the second mounting hole 24 (i.e., the second reference line E2). The other two second protrusions 262 and 263 are disposed on one of the two arcs of the second peripheral part 25 and on the other arc, respectively.

It is preferable that the second protrusions 261, 262 and 263 are arranged so as to be equally spaced apart from each other in 120-degree directions adjacent to each other.

The first protrusion 231 is provided on the first reference line E1, and the second protrusion 261 is provided at a position farthest away from the first protrusion 231 on the same line (the first and second reference lines E1 and E2) along the long side of the lens holder 20.

The lens holder 20 is more likely to be distorted in the long side direction than in the short side direction. Accordingly, by providing the first and second protrusions 231 and 261 at positions farthest away from each other in the long side direction, the first and second objective lenses 31 and 3 can be stably mounted even if distortion occurs in the long side direction.

With reference to FIG. 11, the first objective lens 31 is the same as the objective lenses of the first and second embodiments. The second objective lens 32 has a numerical aperture NA of 0.6, has approximately the same external shape as that of the objective lens shown in FIG. 4, and has the condenser lens part 32a and the flange part 32b. The three first protrusions 231, 232 and 233 are provided so that the first objective lens 31 has a first reference plane ES1 tilted at a first angle α in a tilt direction in which the first protrusion 231 (the center C0 side of the optical disc) has the largest height h1 and the point P1 (outer circumferential side of the optical disc) located at a position 180 degrees from the first protrusion 231 (FIG. 10A) is at the lowest in the cross-section taken along the first reference line E1, for example.

While setting all the protrusions 231, 232 and 233 to have the height to absorb the distortion, for example, in the second peripheral part 25, the one protrusion 261 is set to have a small height h4, and heights h5 and h6 of the protrusions 262 and 263 are set to be the same and higher than the height h4.

Accordingly, the second objective lens 32 has the second reference plane ES2 tilted at a second angle β in a tilt direction in which the height h4 of the second protrusion 261 is at the lowest and the point P2 located at the position 180 degrees from the second protrusion 261 (FIG. 10A) is at the highest.

By appropriately selecting the heights of the second protrusions 261, 262 and 263, (the second reference plane E2 of) the second objective lens 32 having the flange part 32b coming into contact with the second protrusions 261, 262 and 263 can be tilted at a predetermined angle β relative to the plane perpendicular to the optical axis of the laser beam (the plane indicated by the broken line). The tilt direction in this case is, in the cross-section taken along the second reference line E2, the direction (indicated by the arrow) in which the second protrusion 261 (outer circumferential side of the optical disc) is at the lowest and the point P2 (the center C0 side of the optical disc) located at a position 180 degrees from the second protrusion 261 is at the highest.

In the case of, as an example, the objective lens compatible with the optical disc of the DVD/CD standard (the second objective lens 32), the second angle β is an angle (0.15 degree) that is one-half of an angle (approximately 0.3 degree) corresponding to the maximum amount of coma aberration generated by the objective lens.

The second objective lens 32 is mounted and fixed so that the generation direction of coma aberration in the second objective lens 32 is aligned with the tilt direction of the second reference plane ES2.

In this embodiment, the second reference line E2 coincides with the radial direction, and the tilt direction also coincides with the radial direction of the optical disc. Thus, the direction of the coma aberration can be aligned in the radial direction of the optical disc together with the first objective lens 31.

Among the multiple lens holders 20, the respective second protrusions 261, 262 and 263 are provided at the same positions on the ring-shaped second peripheral part 25 in the planar view, and the heights h4, h5 and h6 are set so that the second reference plane ES2 is tilted at the second angle β.

Thus, even when a difference in height is caused by molding distortion or molding variation in the surface of the second peripheral part 25, the second objective lens 32 can be stably supported at the same position and height (height at which the reference plane is tilted at the second angle β among the multiple lens holders 20. More specifically, the second reference plane ES2 for mounting the second objective lens 32 is set to be uniform among the lens holders 20, thus making it possible to reduce an adjustment variation of the second objective lens 32 attributable to molding distortion or molding variation in the lens holder.

When the objective lens for BD and the objective lens for DVD/CD are mounted on one lens holder 20, a posture adjustment operation is performed for the wires supporting the lens holder 20 in order to support the two objective lenses in an optimum state. In this event, there arises a problem that when the posture adjustment operation is performed with one of the objective lenses, the posture of the other objective lens is not optimized but the jitter value is deteriorated. Such a problem is found to be attributable to coma aberration caused by the tilt of the objective lens.

The coma aberration described above is characterized by increasing with an increase in thickness of a protective layer provided on the signal recording layer, by increasing with an increase in a numerical aperture of the objective lens, and by increasing with a decrease in wavelength of the laser beam. Therefore, among the various optical disc standards described above, the objective lens for BD generates the largest coma aberration.

That is, mounting of the objective lens for BD and the objective lens for DVD/CD on one lens holder 20 leads to a problem of increased relative coma aberration due to the difference in coma aberration between the two objective lenses.

For example, when the first objective lens 31 having a numerical aperture NA of 0.85 (objective lens for BD) and the second objective lens 32 having an NA of 0.65 or less (objective lens for DVD/CD) are mounted on one lens holder 20, a general amount of molding variation in coma is approximately ±0.05λ for the former and ±0.03λ for the latter. Accordingly, a relative amount of coma of the two objective lenses turns out to be ±0.08λ.

The coma can be corrected by tilting the objective lenses, and coma of, for example, 0.01λ can be corrected by the tilt of approximately 0.1 degree. In this case, assuming that each fixing variation is ±0.2 degree, the maximum relative amount of coma turns out to be 1.2 degrees, and the performance is deteriorated when the two objective lenses are mounted on one lens holder 20 and correction of the coma aberration is performed simultaneously for both the lenses.

Therefore, in the conventional case, the coma aberrations in the two objective lenses are individually checked, and adjustment in the generation direction of coma aberration and adjustment of tilting the objective lens for cancelling the coma aberration are separately performed.

To be more specific, the coma aberrations in the two objective lenses are corrected by tilting an actuator having a lens holder mounted thereon so as to cancel the angle of coma aberration in the lens for BD after one of the lenses (e.g., the objective lens for DVD) is mounted using a lens holder having a peripheral part with a curvature, on which a flange part of the objective lens is mounted, and the lens is fixed by adjusting an angle and direction of coma aberration, or after one of the lenses is mounted using a lens holder having the lens mounted in a floating state, the lens is attached in the air by adjusting an angle and direction of coma aberration, and the other lens (e.g., the lens for BD) is fixed by adjusting the direction of coma aberration.

Furthermore, the above adjustment needs to be performed for each optical pickup apparatus, resulting in a problem that adjustment of coma aberration in the two objective lenses becomes very cumbersome and complicated, leading to an adjustment variation and increased man-hours.

In this embodiment, as shown in FIG. 11, the first reference plane ES1 of the first objective lens 31 is tilted at the first angle α relative to the plane perpendicular to the optical axis of the laser, while the second reference plane ES2 of the second objective lens 32 is tilted at the second angle β relative to the plane perpendicular to the optical axis of the laser. Accordingly, the optical axes of both the objective lenses can be set within a suitable range relative to the optical axis of the laser beam, thus making it possible to reduce the maximum amount of coma aberration generated by both the objective lenses and to reduce the relative amount of coma.

The first angle α is an angle that is one-half of a correction angle (approximately 0.5 degree) corresponding to the maximum amount of coma aberration (e.g., ±0.05λ) generated by the first objective lens 31 (the objective lens for BD), and is, for example, 0.25 degree from the plane perpendicular to the optical axis of the first laser beam.

The second angle β is an angle that is one-half of a correction angle (approximately 0.3 degree) corresponding to the maximum amount of coma aberration (e.g., ±0.03λ) generated by the second objective lens 32 (the objective lens for CD/DVD), and is, for example, 0.15 degree from the plane perpendicular to the optical axis of the second laser beam.

Thus, the maximum relative amount of coma in the first and second objective lenses 31 and 32 can be reduced, and the molding variation in coma can be corrected, thereby achieving the same effect as the significant reduction in the amount of coma generated by the objective lenses.

Note that the first objective lens 31 is fixed so that the generation direction of the first coma aberration is aligned with the first reference line E, i.e., so that the generation direction of coma aberration is aligned with the tilt direction of the first reference plane ES1. Similarly, the second objective lens 32 is fixed so that the generation direction of the second coma aberration is aligned with the second reference line E2, i.e., so that the generation direction of coma aberration is aligned with the tilt direction of the second reference plane ES2.

Thus, the first and second objective lenses 31 and 32 are fixed on the lens holder 20 so that the generation directions of coma aberrations in the first and second objective lenses 31 and 32 are aligned with the radial direction of the optical disc.

Note that, in the above embodiments, the description has been given of the case where the height h1 of the (first) protrusion 231 is set to be higher than the heights h2 and h3 of the other (first) protrusions 232 and 233 so that the reference plane of the (first) objective lens 31 is tilted at a predetermined angle α.

However, the present invention is not limited to the above case, but the protrusions 231, 232 and 233 may be provided so that the objective lens 31 is tilted and supported by setting the heights of the protrusions 231, 232 and 233 to be such heights at which the reference plane ES of the objective lens 31 becomes horizontal, then mounting the objective lens 31, and pushing the objective lens 31 to be set at a predetermined angle α while applying external energy such as ultrasonic vibration to the protrusions 231, 232 and 233. The same applies to the second protrusions 261, 262 and 263 for the second objective lens 32.

While the reference line E (the first and second reference lines E1 and E2) with which the generation direction of coma aberration is aligned is set to be the radial direction of the optical disc in the above embodiments, the present invention is not limited thereto but the reference line may be provided in the tangential direction of the optical disc or in a direction 45 degrees from the tangential direction.

Furthermore, in the third embodiment, the first and second mounting holes 21 and 24 may be arranged so that the straight line passing the centers thereof is along (parallel to) the tangential direction of the optical disc, for example. In this case, the reference line E (the first and second reference lines E1 and E2) may be provided in the tangential direction.

This invention provides the lens holder which has three protrusions in peripheral part thereof, which come in contact with the flange part of the object lens and support the object lens.

Moreover this invention provides two or more lens holders which support object lens at the same position and height respectively by three protrusions.

Two or more lens holders support object lenses by three protrusions at the same position respectively, each of the lens holder so that the reference plane of object lens is tilted at an appropriate angle relative to the optical axis of the laser beam.

In addition, the lens holder has two peripheral parts which provided three protrusions respectively and support two object lenses, so that the reference planes of two object lenses mounted in one lens holder may incline respectively at the angle that decreases those amounts of the relative coma aberration.

The embodiments of the present invention can achieve the following effects.

First, by providing the three protrusions in the peripheral part of the lens holder, on which the flange part of the objective lens is to be mounted, the objective lens can be supported by the three protrusion tips. Providing the three protrusions each having the height high enough to absorb the molding distortion in the peripheral part allows the objective lenses to be supported uniformly (at the same position and height (angle)) among multiple lens holders, even if there is distortion after molding or molding variation in the peripheral parts of the lens holders. This makes it possible to prevent an adjustment variation attributable to molding variation or molding distortion in the lens holder during rotation adjustment for correcting the coma aberration in the objective lens.

Secondly, when the peripheral part is split into two halves by a line passing through one of the protrusions and the center of the mounting hole, the other two protrusions are disposed on the two arcs of the peripheral part, respectively, thereby enabling the objective lens to be stably supported by the three protrusions.

Third, the three protrusions are disposed equally spaced apart from each other, thereby improving the stability when the objective lens is supported by the three protrusions.

Fourth, the three protrusions are provided to have such heights that a plane including the apexes of the respective protrusions is tilted at a predetermined angle, thus enabling the objective lens to be disposed at a predetermined tilt angle relative to the optical axis of the laser beam. For the objective lens, the maximum amount of coma aberration generated is virtually specific according to a compatible standard of the optical disc (i.e., for BD, DVD or CD). Therefore, tilting the objective lens at an angle that is one-half of an angle corresponding to the maximum amount of coma aberration generated produces the same effect as the reduction in the maximum amount of coma aberration generated.

Fifth, when the objective lenses for BD and for DVD/CD, for example, are mounted on one lens holder, three protrusions are provided in each of two peripheral parts on which flange parts of the two objective lenses are mounted, respectively, thereby enabling the two objective lenses to be uniformly supported (at the same position and height (angle)) among multiple lens holders even if there is a molding variation between the peripheral parts.

Sixth, when two objective lenses are mounted on one lens holder, the peripheral part for each of the objective lenses is provided with such three protrusions that a plane including the apexes of the protrusions is tilted at a predetermined angle, thus enabling each of the objective lenses to be mounted on the lens holder at a predetermined tilt angle relative to the optical axis of the laser beam.

When the two objective lenses are mounted on one lens holder, relative coma aberration of the two objective lenses is generated in addition to the coma aberration of each of the objective lenses. Generally, adjustment for the coma aberration is cumbersome, and molding distortion or molding variation in the mounting part (peripheral part) for each of the objective lenses increases a variation in the amount of relative coma aberration, thus further complicating the adjustment.

However, in the preferred embodiments of the invention, each of the two objective lenses can be stably supported by the three protrusions, and the objective lenses are each tilted in advance at a predetermined angle, i.e., at an angle that is one-half of the angle corresponding to the maximum amount of coma aberration generated, thereby producing the same effect as the reduction in the relative maximum amount of coma aberration generated. As a result, needed man-hours or adjustment variation can be reduced.

Seventh, the adoption of the lens holder described above makes it possible to provide an inexpensive optical pickup apparatus with less performance variation.

What is claimed is:

1. A lens holder supporting an objective lens for focusing a laser beam on a signal recording layer of an optical disc, comprising:
a mounting hole into which a condenser lens part of the objective lens is to be inserted;
a peripheral part surrounding the mounting hole; and
three protrusions provided in the peripheral part to be spaced apart from each other and to protrude from a main surface of the peripheral part, and configured to support a flange part of the objective lens by being in contact with the flange part.

2. The lens holder according to claim 1, wherein
the peripheral part is split into two arcs by a line passing through one of the protrusions and the center of the mounting hole, and the other two protrusions are disposed on the two arcs, respectively.

3. The lens holder according to claim 2, wherein
the protrusions are disposed equally spaced apart from each other.

4. The lens holder according to any one of claims 2 and 3, wherein
the three protrusions are each provided to have a height high enough to absorb molding distortion in the peripheral part.

5. The lens holder according to claim 4, wherein
the protrusions are provided to have such heights that a plane including protrusion apexes of the respective protrusions is tilted at a predetermined angle.

6. The lens holder according to any one of claims 1 to 5, further comprising:
another mounting hole into which a condenser lens part of another objective lens is to be inserted;
another peripheral part surrounding the another mounting hole; and
three another protrusions provided in the another peripheral part to be spaced apart from each other and protrude from a main surface of the another peripheral part, and configured to support a flange part of the another objective lens by being in contact with the flange part.

7. The lens holder according to claim 6, wherein
one of the three another protrusions is provided at a position farthest from the one of the protrusions on the same line along the long side of the lens holder.

8. The lens holder according to any one of claims 6 and 7, wherein
the three another protrusions are each provided to have a height high enough to absorb molding distortion in the another peripheral part.

9. The lens holder according to claim 8, wherein
the three another protrusions are provided to have such heights that another plane including protrusion apexes of the respective another protrusions is tilted at another predetermined angle.

10. An optical pickup apparatus comprising:
a lens holder according to any one of claims 1 to 5, supported by support wires to be movable in a direction perpendicular to a signal recording layer of an optical disc and in a radial direction of the optical disc, and provided with a focus coil; and
an objective lens supported with a condenser lens part inserted into the mounting hole of the lens holder, and with a flange part around the condenser lens part being in contact with the protrusions.

11. An optical pickup apparatus comprising:
a lens holder according to any one of claims 6 to 9, supported by support wires to be movable in a direction perpendicular to a signal recording layer of an optical disc and in a radial direction of the optical disc, and provided with a focus coil;
an objective lens having a condenser lens part inserted into the mounting hole of the lens holder, and with a flange part around the condenser lens part being in contact with the protrusions; and
another objective lens supported with a condenser lens part inserted into the another mounting hole of the lens holder, and with a flange part around the condenser lens part being in contact with the another protrusions.
